(19) United States
(12) Patent Application Publication
(10) Pub. No.: US 2025/0132808 A1
(43) Pub. Date: Apr. 24, 2025

(54) VEHICLE COMMUNICATION SYSTEM WITH MESSAGE RELAYING FUNCTION

(71) Applicant: Honeywell International Inc., Charlotte, NC (US)

(72) Inventors: Divya Swarup Giriyappa Srinivasan, Bangalore (IN); Minni Ambooken, Bangalore (IN); Thomas D. Judd, Phoenix, AZ (US)

(73) Assignee: Honeywell International Inc., Charlotte, NC (US)

(21) Appl. No.: 18/537,628

(22) Filed: Dec. 12, 2023

(30) Foreign Application Priority Data
Oct. 19, 2023 (IN) 202311071457

(51) Int. Cl. H04B 7/185

(52) U.S. Cl. CPC H04B 7/18506

(57) ABSTRACT

A vehicle communication system including at least one receiver/transmitter, and communication unit and a router is provided. The at least one receiver/transmitter receives and transmits data communication messages to at least a remote first ground facility and a remote second ground facility. The communication unit is configured to automatically copy at least portions of select types of data communication messages that are at least one of received from and transmitted to the first ground facility. The router is configured to route the copy of the at least portions of the select types of data communication messages between the communication unit and one receiver/transmitter of the at one receiver/transmitter. The copy of the data communication messages transmitted to the second ground facility is provided so the second ground facility is aware of the data communication messages communicated between a vehicle that includes the vehicle communication system and the first ground facility.

### CROSS-REFERENCE TO RELATED APPLICATIONS

This application claims the benefit of Indian patent application Ser. No. 20/231,1071457, filed on Oct. 19, 2023, same title, which is hereby incorporated herein by reference in its entirety.

### BACKGROUND

Vehicle communication systems are designed to communicate with remote locations. For example, in an avionic application, an aircraft is typically in communication with an airline operation center (AOC) ground facility and an air traffic controller (ATC) ground facility with a vehicle communication system. A flight communications management unit (CMU) may be used in an aircraft for communications. The CMU enables various data and messaging transfers between the aircraft and ground facilities. The CMU may use a datalink application to handle and process communications between a flight crew and an ATC or an AOC. ATC communications typically consist of text messages transmitted between air traffic controllers and the pilots (or flight crew) of the aircraft both in the air and on the ground. ATC messages are predominately operational and may include communications relating to communicating departure clearances, flight plan changes, re-routes and weather information. AOC messages transmitted between pilots and an AOC typically serve to enhance an airlines operation and provide beneficial functionality to increase efficiency, reduce fuel usage, and ensure timely communication and information exchange, logistics, data collection, etc. Sometimes it is desired to inform a ground facility of communications between the vehicle and another ground facility. When the flight crew wants to relay messages between the vehicle and a first ground facility to a second ground facility, the flight crew must format the message for communication with the second ground facility, generate the communication to the second ground facility, and then requests the communication be transmitted to the second ground facility.

For the reasons stated above and for other reasons stated below which will become apparent to those skilled in the art upon reading and understanding the present specification, there is a need in the art for an effective and efficient system to relay communications between a first ground facility and a vehicle to a second ground facility so the second ground facility is aware of the communications.

### SUMMARY

The following summary is made by way of example and not by way of limitation. It is merely provided to aid the reader in understanding some of the aspects of the subject matter described. Embodiments provide a vehicle communication system that copies at least portions of data communications between the vehicle and a first ground facility and then automatically sends the copied at least portions of the communications to a second ground facility so the second ground facility is aware of the data communications.

In one embodiment, a vehicle communication system including at least one receiver/transmitter, and communication unit and a router is provided. The at least one receiver/transmitter receives and transmits data communication messages to at least a remote first ground facility and a remote second ground facility. The communication unit is in communication with the at least one receiver/transmitter. The communication unit is configured to automatically copy at least portions of select types of data communication messages that are at least one of received from and transmitted to the first ground facility. The communication unit including a router. The router is configured to route the copy of the at least portions of the select types of data communication messages between the communication unit and one receiver/transmitter of the at one receiver/transmitter. The copy of the at least portions of the select types of data communication messages is transmitted to the second ground facility so the second ground facility is aware of the data communication messages communicated between a vehicle that includes the vehicle communication system and the first ground facility.

In another embodiment, a vehicle communication system including at least one receiver/transmitter, a database and a CMU is provided. The at least one receiver/transmitter is used to receive and transmit communication messages to at least a remote first ground facility and a remote second ground facility. The CMU includes a database. The database includes information on at least the select types of data communication messages that are to be copied and sent to the one of the first ground facility and second ground facility. The CMU is in communication with the at least one receiver/transmitter and the database, the CMU is configured to automatically copy at least portions of the select types of the data communication messages that are at least one of received from and transmitted to the first ground facility and indicated in the database as the select type of data communication message to be copied, the CMU further configured to transmit the copied at least portions of the select types of the data communication messages that are received from and transmitted to the first ground facility to the second ground facility so the second ground facility is aware of the select types of the data communication messages communicated between a vehicle that includes the CMU and the first ground facility.

In still another embodiment, a method of operating a communication system, the method includes communicating one of a downlink data communication message and an uplink data communication message between a vehicle and a first ground facility using a first receiver/transmitter; copying at least a portion of the communicated one of the downlink data communication message and the uplink data communication message at the vehicle; and communicating the copied at least a portion of the communicated one of the downlink data communication message and the uplink data communication message to at least a second ground facility.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a vehicle with a communication system according to an example aspect of the preset invention;

FIG. 2 is a communication flow diagram that includes an uplink data communication message according to an example aspect of the preset invention; and

FIG. 3 is communication flow diagram that includes a downlink vehicle user data communication message according to an example aspect of the preset invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a vehicle communication system that copies at least portions of data communications between the vehicle and a first ground facility and then automatically formats and sends the copied at least portions of the communications to a second ground facility. The system allows the second ground facility to be aware of data communications, such as datalink communications, between the vehicle and the first ground facility which the second ground facility would not be aware of without the coping and sending of at least portions of the data communications to the second ground facility.

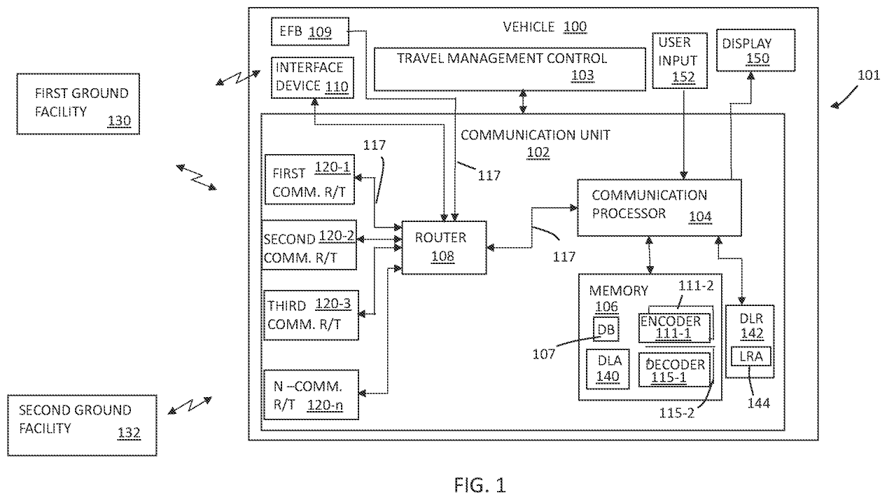

An example of a vehicle 100 that includes a communication system 101 with a communication unit 102 is illustrated in the block diagram of FIG. 1. Communication unit 102 includes a communication processor 104 and a memory 106.

In general, the communication processor 104 may include any one or more of a processor, microprocessor, a digital signal processor (DSP), an application specific integrated circuit (ASIC), a field program gate array (FPGA), or equivalent discrete or integrated logic circuitry. In some example embodiments, communication processor 104 may include multiple components, such as any combination of one or more microprocessors, one or more controllers, one or more DSPs, one or more ASICs, one or more FPGAs, as well as other discrete or integrated logic circuitry. The functions attributed to the communication processor 104 herein may be embodied as software, firmware, hardware or any combination thereof. The communication processor 104 may be part of a system controller or a component controller. The memory 106 may include computer-readable operating instructions that, when executed by the communication processor provides functions of the vehicle communication system. Such functions may include the functions of copying at least portions of communications between the vehicle 100 and a first ground facility and then automatically sends the copied communications to a second ground facility described below. The computer readable instructions may be encoded within memory 106. Memory 106 is an appropriate non-transitory storage medium or media including any volatile, nonvolatile, magnetic, optical, or electrical media, such as, but not limited to, a random-access memory (RAM), read-only memory (ROM), non-volatile RAM (NVRAM), electrically-erasable programmable ROM (EEPROM), flash memory, or any other storage medium.

In an avionic application, the vehicle communication unit 102 may be a CMU. The communication unit 102 in this example further includes router 108 that is in communication with the communication processor 104. In an avionic example, router 108 may be an aircraft communication addressing and reporting system (ACARS) router used to send and receive datalink messages between the aircraft and ground facilities. One or more buses 117 may be used to communicate messages between router 108 and the communication processor 104 of the communication unit 102 (a CMU in an example). An example of an avionic bus 117 that may be used is an aeronautical radio incorporated (ARINC) 429 bus. Although router 108 is illustrated as being part of the communication unit 102 in the example of FIG. 1, the router 108, in other examples, may be external to the communication unit 102.

Router 108 is configured to route communication signals between different communication receivers/transmitter systems and the communication processor 104 of the CMU. The router 108 may also be in communication with an interface device 110 or an electronic flight bag (EFB 109) outside of the CMU that includes their own receiver/transmitters. In the avionic example, the interface device 110 is an aircraft interface device (AID). The different communication receivers/transmitters are used to communicate with remote locations. In this example, the different communication receivers/transmitter include a first communication receiver/transmitter 120-1, a second communication receiver/transmitter 120-2, and third communication receiver/transmitter 102-3 and a N communication receiver/transmitter 120-n. The receiver/transmitters may be generally referenced by 120. Each communication receiver/transmitter system 120 may be configured to communicate via unique format to a remote location such as the first ground facility 130 or the second ground facility 132. In one example, the CMU uses an aeronautical telecommunication network (ATN) protocol format in communicating data communication messages.

In an avionic example, the first communication receiver/transmitter 120-1 may be a satellite communication receiver/transmitter, the second communication receiver/transmitter 120-2 may be a very high frequency (VHF) receiver/transmitter, the third communication receiver/transmitter 120-3 may be a high frequency (HF) receiver/transmitter and the N-communication receiver/transmitter 120-n may include low-cost communication receiver/transmitter systems such as, but not limited to, cellular communication receiver/transmitter systems that include 4G, 5G, etc., as well as WiFi receiver/transmitter (interfaces). Further in an avionic example, the first ground facility 130 may be an ATC ground facility and the second ground facility may be an airline operation center (AOC) ground facility that are configured to communicate with the communication unit 102 of the vehicle through one of the communication receiver/transmitter systems.

In an avionic application example, when the communication unit 102 (the CMU) receives or transmits an air traffic services (ATS) message from or to a first ground facility (130) (the ATC), at least a portion of the ATS message is copied and relayed to a second ground facility 132 (the AOC in this example). This provides the AOC a real time awareness on the ATC/pilot communications. Sending the ATS message can be as a complete message or a partial message that includes key information in the ATS message that would be helpful to the AOC ground facility. The ATC message information can be consumed by an AOC application software of the AOC just as any other broadcast data and let an AOC logic unit monitor of the AOC generate AOC uplinks based on AOC logic unit conditions. This helps to address a situation where in the absence of data from a travel management control 103 (a flight management control (FMC) in an avionic application) in uplink/downlink data from the FMC can be used by the AOC to generate insights for AOC. ATS messages may include controller pilot data link communications (CPDLC), flight information services (FIS), automatic dependent surveillance (ADS), ATS facilities notification/contract management (AFN/CM), and potentially aeronautical radio incorporated (ARINC) 702 (FMC AOC Messages).

In an example, a datalink application 140 stored in memory 106 that is implemented by communication processor 104, automatically relays the ATC sent/received messages to the AOC ground facility. The feature can be further enhanced by providing configurability on the type of messages and/or portions of messages to be relayed from ATC to AOC ground facility. Memory 106 may include one or more databases, such as database 107 (DB). Database 107 may include information relating to select types of data communication messages that are to be copied and sent to a select ground facility. In one example, the communication processor 104 of the communication unit 102 implements instructions stored the memory 106 to determine the select types of data communication messages received from and transmitted to a first ground facility 130 should be copied to a second ground facility based on stored database 107 information. In an example where data messages are being exchanged between an ATC ground facility (first ground facility 130) and the vehicle 100, the database 107 may be an AOC database that includes information relating to what information is of interest to the AOC (i.e., the select types of data communication messages).

Further, in an example, the communication system 101 includes a datalink recorder 142 that is used to record communications. In one example the datalink recorder 142 may be part of memory 106 or as illustrated in FIG. 1, the datalink recorder 142 may be separate and include its own memory. The use of a datalink recorder 142 is required in at least some avionic applications. The datalink recorder 142 includes a link recorder application 144 (LRA) with instructions implemented by the communication processor 104 that may instruct the communication processor 104 to store certain types of messages or certain portions of messages.

The communication processor 104 and datalink application 140 (DLA) of the communication unit 102 may be part of the CMU/communication management function (CMF) in an avionic example. Further in an example, a datalink recorder header is used to identify ATC messages and an AOC encoder 111-1 is used to encode downlink communication as AOC messages to the AOC (second ground facility 132). In the example of FIG. 1, the encoder 111-1 includes instructions stored in memory 106 that are implemented by the communication processor 104. Also included in memory 106 is an AOC decoder 115-1, in this example, that includes instructions implemented by the communication processor 104 to decode received messages. There may be more than the AOC encoder 111-1 and AOC decoder 115-1, for example, the CMU (communication unit 102) may also include an ATC encoder 111-2 and an ATC encoder 115-2 as well as other types of encoders and decoders. An encoder may generally be referenced by 111 and a decoder may generally be referenced by 115.

The relaying an ATC messages to an AOC ground facility, the second ground facility 132 in this example, may occur using low-cost networks like ACARS over internet protocol (AOIP), 4G, 5G, or a satellite communication link provided by one of the first communication receiver/transmitter 120-1 (First Comm. R/T) through the N communication receiver/transmitter 120-n. Further, the messages, such as the ATC messages, may be forwarded to another avionics system, such as interface device 110 or an EFB 109 outside the CMU in an avionic application. The other avionic system then handles the transmission of messages to the AOC ground facility.

The communication system 101 of vehicle 100 in the example of FIG. 1 further includes a display 150 to display received data communication messages and a user input 152 to at least generate vehicle user generated data communication messages that are communicated to ground facilities.

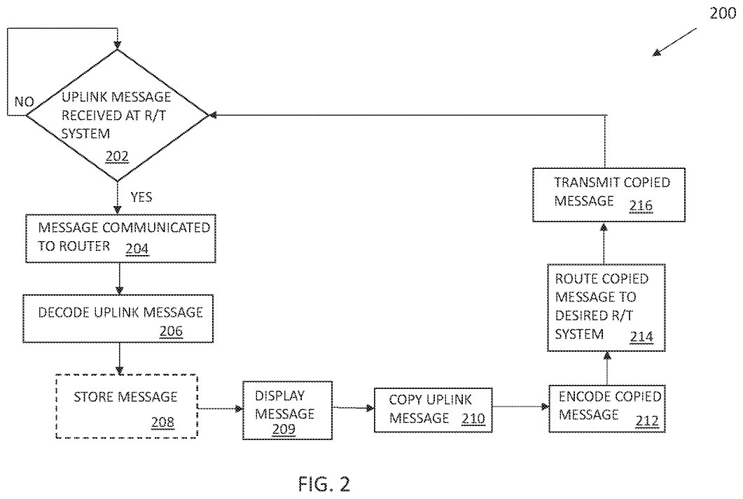

In an avionic example, a method to implement the vehicle communication system with message relaying function with an ATC uplink communication message is provided in view of the communication flow diagram 200 of FIG. 2. Communication flow diagram 200 is illustrated as including a sequential series of blocks. The sequence of blocks may occur in a different order including occurring in parallel in other examples. Hence, the invention is not limited to the sequential series of the blocks set out in communication flow diagram 200.

In the communication flow diagram 200 example, when an ATC uplink data communication message is received at a receiver/transmitter system of the vehicle at block 202, the message is communicated to router 108 at block 204. The uplink data communication message is received at one of the receiver/transmitter systems described above. The receiver/transmitted systems include the first communication receiver/transmitter 120-1, the second communication receiver/transmitter 120-2, the third communication receiver/transmitter 120-3, the N communication receiver/transmitter 120-n, or a receiver/transmitter in of the interface device 110 and EFB 109. In one example, the uplink data communication message is a data uplink message.

The router 108, in this example, forwards the message to the communication processor 104 which implements the instructions in the decoder 115 at block 206 to decode the message. In one example, a DLR header is used to identify an ATC uplink message. The message may be stored in data log recorder 142 (DLR) at block 208 in one example. Further, the uplink message, in an example, is displayed on display 150 of the vehicle 100 at block 209.

A copy of the uplink message is made at block 210. In one example, at least a portion of the uplink message is copied at block 210. The copied message may then be encoded for communication with a second ground facility at block 212. The encoding may include formatting for a desired type of communication. In one example, where the copied massage is to be transmitted to an AOC, the copied message is encoded with an AOC label. An AOC encoder may be used to send as AOC message to an AOC ground facility in an example. The copied message is then routed to a desired receiver/transmitter system at block 214. In one embodiment this is done by router 108. It may be desired to communicate the copied message with a low-cost option. The receiver/transmitter system may be selected based on that desire. Further it may be desired to use a more secure communication format. Hence, in that example a different receiver/transmitter system that is more secure may be selected.

The copied message is then transmitted by the desired receiver/transmitter system at block 216 to a desired different ground facility. As discussed above, the receiver/transmitter system may be outside the CMU, such as for example in the EFB 109 or another interface device 110. In embodiments, the process happens automatically without input from an operator of the vehicle and provides the second ground facility 132 (the AOC ground facility in this example) data communications second ground facility 132 would not otherwise be aware of. The process then continues at block 202.

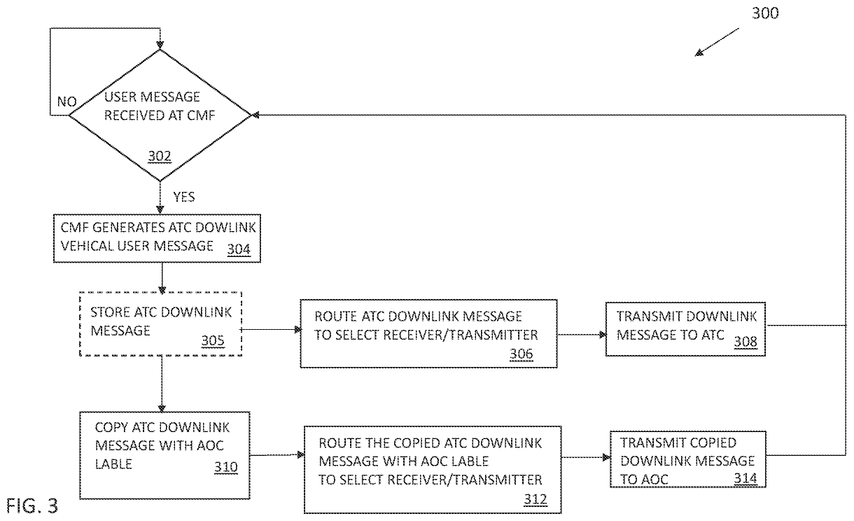

In an avionic example, a method to implement the vehicle communication system with message relaying function with a vehicle user input 152 communication message is provided in view of the communication flow diagram 300 of FIG. 3. Communication flow diagram 300 is illustrated as including a sequential series of blocks. The sequence of the blocks may be in a different order including occurring in parallel in other examples. Hence, the invention is not limited to the sequence of the blocks set out in communication flow diagram 300.

At block 302 it is determined if a vehicle user message is received at the CMU. For example, the vehicle user message may be generated by the flight crew through user input 152 in response to an uplink message from an ATC. When the CMU receives a vehicle user message, the CMU generates an ATC downlink message in response to the vehicle user message at block 304.

The ATC downlink message is stored, in one example, at block 305. For example, the ATC downlink message may be stored in datalink recorder 142. The ATC downlink message is then routed to a select receiver/transmitter system at block 306 and the ATC downlink message is transmitted by the selected receiver/transmitter to the ATC at block 308.

The ATC downlink message is further copied at block 310 with an AOC label (or header). In one example, this is done by identifying the ATC downlink message by a DLR header with a decoder 115 and then using an AOC encoder 111 on the ATC downlink message to generate the AOC label. The downlink message with the AOC label is then routed to a select receiver/transmitter system at block 312 and the ATC downlink message with AOC label is transmitted by the selected receiver/transmitter to the ATC at block 314. The process then continues at block 302 when another user message is received at the CMF.

In the above examples the router and/or the communication processor selects the receiver/transmitter system to use in communicating a downlink signal to one of the ground facilities based on a considered factors such as, but not limited to, availability, cost, reliability, security, etc. Besides the receiver/transmitter systems provided with the first communication receiver/transmitter 120-1, the second communication receiver/transmitter 120-2, the third communication receiver/transmitter 120-3, or the N receiver/transmitter 120-n in the communication unit 102 (the CMU in an example) being used for communications based the considered factors, the receiver/transmitter system selected may also be outside the CMU in the EFB 109, interface device 110 or other communication system used by the vehicle.

Further, examples provided above describe a situation where data communication message between the first ground facility 130 (which may be an ATC) and vehicle 100 are copied and send to the second ground facility 132 (which may be an AOC). At least portions of data communications between the second ground facility 132 and vehicle 100 may also be automatically copied and sent to first ground facility 130 in an example. Further, embodiments may automatically copy data communication messages between a ground facility and a vehicle and send at least portions of the data communications to more than one other ground facility in a similar manner.

### Example Embodiments

Example 1 is a vehicle communication system including at least one receiver/transmitter, and communication unit and a router. The at least one receiver/transmitter receives and transmits data communication messages to at least a remote first ground facility and a remote second ground facility. The communication unit is in communication with the at least one receiver/transmitter. The communication unit is configured to automatically copy at least portions of select types of data communication messages that are at least one of received from and transmitted to the first ground facility. The communication unit including a router. The router is configured to route the copy of the at least portions of the select types of data communication messages between the communication unit and one receiver/transmitter of the at one receiver/transmitter. The copy of the at least portions of the select types of data communication messages is transmitted to the second ground facility so the second ground facility is aware of the data communication messages communicated between a vehicle that includes the vehicle communication system and the first ground facility.

Example 2 includes the vehicle communication system of Example 1, wherein the communication unit is a CMU, the first ground facility is an ATC ground facility and the second ground facility is an AOC ground facility.

Example 3 includes the vehicle communication system of Example 2, further wherein the CMU is configured to forward the copy of the at least portions of the select types of data communication messages to at least one of an EFB and an AID for transmission to the AOC ground facility through the router.

Example 4 included the vehicle communication system of any of the Examples 2-3, further including an AOC database including at least the select types of data communication messages that are to be copied and sent to the AOC ground facility. The CMU is configured to use the AOC database in determining the select types of data communication messages received from and transmitted to the ATC ground facility to copy and transmit to the AOC ground facility.

Example 5 includes the vehicle communication system of any of the Examples 2-4, wherein the router is an ACARS router that is in communication with the CMU, the ACARS router configured to send and receive the communication messages as datalink messages between the CMU and the first ground facility and the second ground facility.

Example 6 includes the vehicle communication system of any of the Example 1-5, wherein a first type of communication is used to communicate the data communication messages between the communication unit and the first ground facility and a second type of communication is used to communicate the copy of the at least portions of the select types of data communication messages to the second ground facility.

Example 7, includes the vehicle communication system of Example 6, wherein the second type of communication is achieved through at least one of a satellite communication receiver/transmitter, a VHF receiver/transmitter, a HF receiver/transmitter, a cellular communication receiver/transmitter, and a WiFi receiver/transmitter.

Example 8 includes a vehicle communication system including at least one receiver/transmitter, a database and a CMU. The at least one receiver/transmitter is used to receive and transmit communication messages to at least a remote first ground facility and a remote second ground facility. The CMU includes a database. The database includes information on at least the select types of data communication messages that are to be copied and sent to the one of the first ground facility and second ground facility. The CMU is in communication with the at least one receiver/transmitter and the database, the CMU is configured to automatically copy at least portions of the select types of the data communication messages that are at least one of received from and transmitted to the first ground facility and indicated in the database as the select type of data communication message to be copied, the CMU further configured to transmit the copied at least portions of the select types of the data communication messages that are received from and transmitted to the first ground facility to the second ground facility so the second ground facility is aware of the select types of the data communication messages communicated between a vehicle that includes the CMU and the first ground facility.

Example 9 includes the vehicle communication system of Example 8, wherein the first ground facility is an ATC ground facility and the second ground facility is an AOC ground facility.

Example 10 includes the vehicle communication system of Example 9, further wherein the CMU is configured to forward the copy of the at least portions of the select types of data communication messages to at least one of an EFB and an AID for transmission to the AOC ground facility.

Example 11 includes the vehicle communication system of any of the Examples 9-10, wherein the database is an AOC database that includes at least select types of data communication messages that are to be copied and sent to the AOC ground facility, the CMU configured to use the AOC database in determining the select types of data communication messages received from and transmitted to the ATC ground facility to copy and transmit to the AOC ground facility.

Example 12 includes the vehicle communication system of any of the Examples 8-11, wherein a first type of communication is used to communicate the data communication messages between the CMU and the first ground facility and a second type of communication is used to communicate the copy of the at least portions of the select types of data communication messages to the second ground facility.

Example 13 includes the vehicle communication system of Example 12, wherein the second type of communication is achieved through at least one of a satellite communication receiver/transmitter, a VHF receiver/transmitter, a HF receiver/transmitter, a cellular communication receiver/transmitter, and a WiFi receiver/transmitter.

Example 14 includes the vehicle communication system of any of the Examples 8-13, further including an ACARS router in communication with the CMU, the ACARS router configured to send and receive the communication messages as datalink messages between the CMU and the first ground facility and the second ground facility.

Example 15 includes the vehicle communication system of any of the Examples 8-14, wherein the CMU uses an ATN protocol format in communicating the communication messages.

Example 16 includes a method of operating a communication system, the method includes communicating one of a downlink data communication message and an uplink data communication message between a vehicle and a first ground facility using a first receiver/transmitter; copying at least a portion of the communicated one of the downlink data communication message and the uplink data communication message at the vehicle; and communicating the copied at least a portion of the communicated one of the downlink data communication message and the uplink data communication message to at least a second ground facility.

Example 17 includes the method of Example 16, further including encoding the copied at least a portion of the communicated one of the downlink data communication message and the uplink data communication message to identify the copied at least a portion of the communicated one of the downlink data communication message and the uplink data communication message is to be communicated to the at least one second ground facility.

Example 18 includes the method of any of the Examples 16-17, wherein the encoding includes using a header that identifies the at one second ground facility.

Example 19 includes the method of any of the Examples 16-18, further including routing the copied at least a portion of the communicated one of the downlink data communication message and the uplink data communication message is to be communicated to the at least one second ground facility to a select second receiver/transmitter.

Example, 20 includes the method of any of the Examples 16-19, further including storing the one of the downlink data communication message and the uplink data communication message in a datalink recorder.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A vehicle communication system comprising:
at least one receiver/transmitter to receive and transmit data communication messages to at least a remote first ground facility and a remote second ground facility;
a communication unit in communication with the at least one receiver/transmitter, the communication unit configured to automatically copy at least portions of select types of the data communication messages that are at least one of received from and transmitted to the first ground facility, the communication unit including a router; and
the router configured to route the copy of the at least portions of the select types of the data communication messages between the communication unit and one receiver/transmitter of the at least one receiver/transmitter where the copy of the at least portions of the select types of the data communication messages is transmitted to the second ground facility so the second ground facility is aware of the data communication messages communicated between a vehicle that includes the vehicle communication system and the first ground facility.

2. The vehicle communication system of claim 1, wherein the communication unit is a communication management unit (CMU), the first ground facility is an air traffic controller (ATC) ground facility and the second ground facility is an airline operation center (AOC) ground facility.

3. The vehicle communication system of claim 2, further wherein the CMU is configured to forward the copy of the at least portions of the select types of the data communication messages to at least one of an electronic flight bag (EFB) and an aircraft interface device (AID) for transmission to the AOC ground facility through the router.

4. The vehicle communication system of claim 2, further comprising:
an AOC database including at least the select types of the data communication messages that are to be copied and sent to the AOC ground facility, the CMU configured to use the AOC database in determining the select types of the data communication messages received from and transmitted to the ATC ground facility to copy and transmit to the AOC ground facility.

5. The vehicle communication system of claim 2, wherein the router is an addressing and reporting system (ACARS) router that is in communication with the CMU, the ACARS router configured to send and receive the data communication messages as datalink messages between the CMU and the first ground facility and the second ground facility.

6. The vehicle communication system of claim 1, wherein a first type of communication is used to communicate the data communication messages between the communication unit and the first ground facility and a second type of communication is used to communicate the copy of the at least portions of the select types of the data communication messages to the second ground facility.

7. The vehicle communication system of claim 6, wherein the second type of communication is achieved through at least one of a satellite communication receiver/transmitter, a very high frequency (VHF) receiver/transmitter, a high frequency (HF) receiver/transmitter, a cellular communication receiver/transmitter, and a WiFi receiver/transmitter.

8. A vehicle communication system comprising:
at least one receiver/transmitter to receive and transmit communication messages to at least a remote first ground facility and a remote second ground facility;
a communication management unit (CMU) including a database;
the database including information on at least select types of data communication messages that are to be copied and sent to the one of the first ground facility and the second ground facility; and
the CMU is in communication with the at least one receiver/transmitter and the database, the CMU is configured to automatically copy at least portions of the select types of the data communication messages that are at least one of received from and transmitted to the first ground facility and indicated in the database as a select type of data communication message to be copied, the CMU further configured to transmit the copied at least portions of the select types of the data communication messages that are received from and transmitted to the first ground facility to the second ground facility so the second ground facility is aware of the select types of the data communication messages communicated between a vehicle that includes the CMU and the first ground facility.

9. The vehicle communication system of claim 8, wherein the first ground facility is an air traffic controller (ATC) ground facility and the second ground facility is an airline operation center (AOC) ground facility.

10. The vehicle communication system of claim 9, further wherein the CMU is configured to forward the copy of the at least portions of the select types of the data communication messages to at least one of an electronic flight bag (EFB) and an aircraft interface device (AID) for transmission to the AOC ground facility.

11. The vehicle communication system of claim 9, wherein the database is an AOC database that includes the at least select types of the data communication messages that are to be copied and sent to the AOC ground facility, the CMU configured to use the AOC database in determining the select types of the data communication messages received from and transmitted to the ATC ground facility to copy and transmit to the AOC ground facility.

12. The vehicle communication system of claim 8, wherein a first type of communication is used to communicate the data communication messages between the CMU and the first ground facility and a second type of communication is used to communicate the copy of the at least portions of the select types of the data communication messages to the second ground facility.

13. The vehicle communication system of claim 12, wherein the second type of communication is achieved through at least one of a satellite communication receiver/transmitter, a very high frequency (VHF) receiver/transmitter, a high frequency (HF) receiver/transmitter, a cellular communication receiver/transmitter, and a WiFi receiver/transmitter.

14. The vehicle communication system of claim 8, further comprising:
an addressing and reporting system (ACARS) router in communication with the CMU, the ACARS router configured to send and receive the data communication messages as datalink messages between the CMU and the first ground facility and the second ground facility.

15. The vehicle communication system of claim 8, wherein the CMU uses an aeronautical telecommunication network (ATN) protocol format in communicating the communication messages.

16. A method of operating a communication system, the method comprising:
communicating one of a downlink data communication message and an uplink data communication message between a vehicle and a first ground facility using a first receiver/transmitter;
copying at least a portion of the communicated one of the downlink data communication message and the uplink data communication message at the vehicle; and
communicating the copied at least the portion of the communicated one of the downlink data communication message and the uplink data communication message to at least a second ground facility.

17. The method of claim 16, further comprising:
encoding the copied at least the portion of the communicated one of the downlink data communication message and the uplink data communication message to identify the copied at least the portion of the communicated one of the downlink data communication message and the uplink data communication message is to be communicated to the at least one second ground facility.

18. The method of claim 17, wherein the encoding includes using a header that identifies the at one second ground facility.

19. The method of claim 16, further comprising:
routing the copied at least the portion of the communicated one of the downlink data communication message and the uplink data communication message is to be communicated to the at least one second ground facility to a select second receiver/transmitter.

20. The method of claim 16, further comprising:
storing the one of the downlink data communication message and the uplink data communication message in a datalink recorder.
